(19) United States
(12) Patent Application Publication
(10) Pub. No.: US 2003/0099200 A1
(43) Pub. Date: May 29, 2003

(54) Parallel limit checking in a hierarchical network for bandwidth management traffic-shaping cell

(75) Inventors: Frederick Kiremidjian, Danville, CA (US); Li-Ho Raymond Hou, Saratoga, CA (US)

Correspondence Address: LAW OFFICES OF THOMAS E. SCHATZEL, A Professional Corporation, Suite 240, 16400 Lark Avenue, Los Gatos, CA, 95032-2547, US

(73) Assignee: AMPLIFY.NET, INC.

(21) Appl. No.: 10/004,608

(22) Filed: Nov. 27, 2001

(51) Int. Cl. H04L 12/26

(52) U.S. Cl. 370/230.1; 370/412

(57) ABSTRACT

A method and a semiconductor intellectual property embodiment of the present invention comprise a class-based queue traffic shaper that enforces multiple service-level agreement policies on individual connection sessions by limiting the maximum data throughput for each connection. The class-based queue traffic shaper distinguishes amongst datapackets according to their respective source and/or destination IP-addresses. All limit checking is done in one clock cycle for the entire network hierarchy above a particular node, and previously independent and separate queues are combined into one super queue.

### BACKGROUND OF THE INVENTION

1. Field of the Invention

The invention relates generally to computer network protocols and equipment for adjusting packet-by-packet bandwidth according to the source and/or destination IP-addresses of each such packet. More specifically, the present invention relates to practical hardware implementations of single queues and bandwidth traffic-shaping cells in semiconductor integrated circuits.

2. Description of the Prior Art

Access bandwidth is important to Internet users. New cable, digital subscriber line (DSL), and wireless “always-on” broadband-access together are expected to eclipse dial-up Internet access in 2001. So network equipment vendors are scrambling to bring a new generation of broadband access solutions to market for their service-provider customers. These new systems support multiple high speed data, voice and streaming video Internet-protocol (IP) services, and not just over one access media, but over any media.

Flat-rate access fees for broadband connections will shortly disappear, as more subscribers with better equipment are able to really use all that bandwidth and the systems' overall bandwidth limits are reached. One of the major attractions of broadband technologies is that they offer a large Internet access pipe that enables a huge amount of information to be transmitted. Cable and fixed point wireless technologies have two important characteristics in common. Both are “fat pipes” that are not readily expandable, and they are designed to be shared by many subscribers.

Although DSL allocates a dedicated line to each subscriber, the bandwidth becomes “shared” at a system aggregation point. In other words, while the bandwidth pipe for all three technologies is “broad,” it is always “shared” at some point and the total bandwidth is not unlimited. All broadband pipes must therefore be carefully and efficiently managed.

Internet Protocol (IP) datapackets are conventionally treated as equals, and therein lies one of the major reasons for its “log jams”. When all IP-packets have equal right-of-way over the Internet, a “first come, first serve” service arrangement results. The overall response time and quality of delivery service is promised to be on a “best effort” basis only. Unfortunately all IP-packets are not equal, certain classes of IP-packets must be processed differently.

In the past, such traffic congestion has caused no fatal problems, only an increasing frustration from the unpredictable and sometimes gross delays. However, new applications use the Internet to send voice and streaming video IP-packets that mix-in with the data IP-packets. These new applications cannot tolerate a classless, best efforts delivery scheme, and include IP-telephony, pay-per-view movie delivery, radio broadcasts, cable modem (CM), and cable modem termination system (CMTS) over two-way transmission hybrid fiber/coax (HFC) cable.

Internet service providers (ISPs) need to be able to automatically and dynamically integrate service subscription orders and changes, e.g., for “on demand” services. Different classes of services must be offered at different price points and quality levels. Each subscriber's actual usage must be tracked so that their monthly bills can accurately track the service levels delivered. Each subscriber should be able to dynamically order any service based on time of day/week, or premier services that support merged data, voice and video over any access broadband media, and integrate them into a single point of contact for the subscriber.

There is an urgent demand from service providers for network equipment vendors to provide integrated broadband-access solutions that are reliable, scalable, and easy to use. These service providers also need to be able to manage and maintain ever growing numbers of subscribers.

Conventional IP-addresses, as used by the Internet, rely on four-byte hexadecimal numbers, e.g., 00H-FFH. These are typically expressed with four sets of decimal numbers that range 0-255 each, e.g., “192.55.0.1”. A single look-up table could be constructed for each of 4,294,967,296 (256⁴) possible IP-addresses to find what bandwidth policy should attach to a particular datapacket passing through. But with only one byte to record the policy for each IP-address, that approach would require more than four gigabytes of memory. So this is impractical.

There is also a very limited time available for the bandwidth classification system to classify a datapacket before the next datapacket arrives. The search routine to find which policy attaches to a particular IP-address must be finished within a finite time. And as the bandwidths get higher and higher, these search times get proportionally shorter.

The straight forward way to limit-check each node in a hierarchical network is to test whether passing a just received datapacket would exceed the policy bandwidth for that node. If yes, the datapacket is queued for delay. If no, a limit-check must be made to see if the aggregate of this node and all other daughter nodes would exceed the limits of a parent node. And then a grandparent node, and so on. Such sequential limit check of hierarchical nodes was practical in software implementations hosted on high performance hardware platforms. But it is impractical in a pure hardware implementation, e.g., a semiconductor integrated circuit.

### SUMMARY OF THE PRESENT INVENTION

It is therefore an object of the present invention to provide a semiconductor intellectual property for controlling network bandwidth at a local site according to a predetermined policy.

It is another object of the present invention to provide a semiconductor intellectual property that implements in hardware a traffic-shaping cell that can control network bandwidth at very high datapacket rates and in real time.

It is a further object of the present invention to provide a method for traffic-shaping that can control network bandwidth at very high datapacket rates and in real time.

Briefly, a semiconductor intellectual property embodiment of the present invention comprises a class-based queue traffic shaper that enforces multiple service-level agreement policies on individual connection sessions by limiting the maximum data throughput for each connection. The class-based queue traffic shaper distinguishes amongst datapackets according to their respective source and/or destination IP-addresses. All limit checking is done in one clock cycle for the entire network hierarchy above a particular node, and previously independent and separate queues are combined into one super queue.

An advantage of the present invention is a device and method are provided for allocating bandwidth to network nodes according to a policy.

A still further advantage of the present invention is a semiconductor intellectual property is provided that prioritizes datapacket transfers according to service-level agreement policies in real time and at high datapacket rates.

These and many other objects and advantages of the present invention will no doubt become obvious to those of ordinary skill in the art after having read the following detailed description of the preferred embodiments which are illustrated in the drawing figures.

### IN THE DRAWINGS

FIG. 1 is a schematic diagram of a hierarchical network embodiment of the present invention with a gateway to the Internet;

FIG. 2 is a diagram of a single queue embodiment of the present invention for checking and enforcing bandwidth service level policy management in a hierarchical network; and

FIG. 3 is a functional block diagram of a system of interconnected semiconductor chip components that include a traffic-shaping cell and classifier, and that implements various parts of FIGS. 1 and 2.

### DETAILED DESCRIPTION OF THE PREFERRED EMBODIMENTS

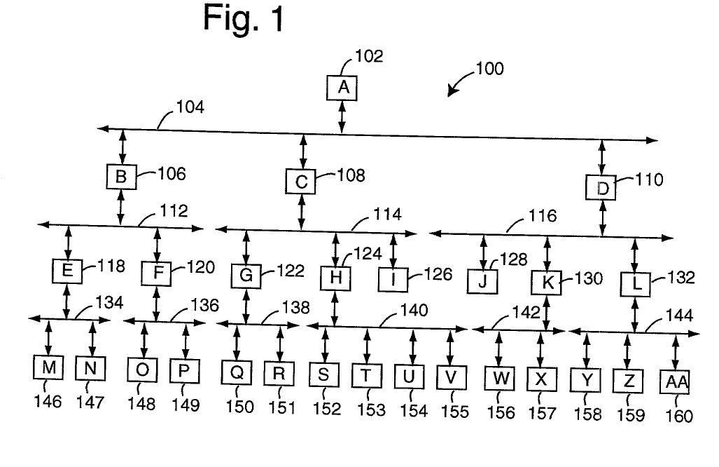

FIG. 1 represents a hierarchical network embodiment of the present invention, and is referred to herein by the general reference numeral 100. The network 100 has a hierarchy that is common in cable network systems. Each higher level node and each higher level network is capable of data bandwidths much greater than those below it. But if all lower level nodes and networks were running at maximum bandwidth, their aggregate bandwidth demands would exceed the higher level's capabilities.

The network 100 therefore includes bandwidth management that limits the bandwidth made available to daughter nodes, e.g., according to a paid service-level policy. Higher bandwidth policies are charged higher access rates. Even so, when the demands on all the parts of a branch exceed the policy for the whole branch, the lower-level demands are trimmed back. For example, to keep one branch from dominating trunk-bandwidth to the chagrin of its peer branches.

The present Assignee, Amplify.net, Inc., has filed several United States patent applications that describe such service-level policies and the mechanisms to implement them. Such include INTERNET USER-BANDWIDTH MANAGEMENT AND CONTROL TOOL, now U.S. Pat No. 6,085,241, issued Mar. 14, 2000; BANDWIDTH SCALING DEVICE, Ser. No. 08/995,091, filed Dec. 12, 1997; BANDWIDTH ASSIGNMENT HIERARCHY BASED ON BOTTOM-UP DEMANDS, Ser. No. 09/718,296, filed Nov. 21, 2000; NETWORK-BANDWIDTH ALLOCATION WITH CONFLICT RESOLUTION FOR OVERRIDE, RANK, AND SPECIAL APPLICATION SUPPORT, Ser. No. 09/716,082, filed Nov. 16, 2000; GRAPHICAL USER INTERFACE FOR DYNAMIC VIEWING OF DATAPACKET EXCHANGES OVER COMPUTER NETWORKS, Ser. No. 09/729,733, filed Dec. 14, 2000; ALLOCATION OF NETWORK BANDWIDTH ACCORDING TO NETWORK APPLICATION, Ser. No. 09/718,297, filed Nov. 21, 2001; METHOD FOR ASCERTAINING NETWORK BANDWIDTH ALLOCATION POLICY ASSOCIATED WITH APPLICATION PORT NUMBERS, (Docket SS-709-07) Ser. No. ______ filed Aug. 2, 2001; and METHOD FOR ASCERTAINING NETWORK BANDWIDTH ALLOCATION POLICY ASSOCIATED WITH NETWORK ADDRESS, (Docket SS-709-08) Ser. No. ______ filed Aug. 7, 2001. All of which are incorporated herein by reference.

Suppose the network 100 represents a city-wide cable network distribution system. A top trunk 102 provides a broadband gateway to the Internet and it services a top main trunk 104, e.g., having a maximum bandwidth of 100-Mbps. At the next lower level, a set of cable modem termination systems (CMTS) 106, 108, and 110, each classifies traffic into data, voice and video 112, 114, and 116. If each of these had bandwidths of 45-Mbps, then all three running at maximum would need 135-Mbps at top main trunk 104 and top gateway 102. A policy-enforcement mechanism is included that limits, e.g., each CMTS 106, 108, and 110 to 45-Mbps and the top Internet trunk 102 to 100-Mbps. If all traffic passes through the top Internet trunk 102, such policy-enforcement mechanism can be implemented there alone.

Each CMTS supports multiple radio frequency (RF) channels 118, 120, 122, 124, 126, 128, 130, and 132, which are limited to a still lower bandwidth, e.g., 38-Mbps each. A group of neighborhood networks 134, 136, 138, 140, 142, and 144, distribute bandwidth to end users 146-160, e.g., individual cable network subscribers residing along neighborhood streets. Each of these could buy 5-Mbps bandwidth service level policies, for example.

The integration of class-based queues and datapacket classification mechanisms in semiconductor chips necessitates more efficient implementations, especially where bandwidths are exceedingly high and the time to classify and policy-check each datapacket is exceedingly short. Therefore, embodiments of the present invention describes a new approach which manages every datapacket in the whole network 100 from a single queue. Rather, as in previous embodiments, than maintaining queues for each node A-Z, and AA, and checking the bandwidth limit of all hierarchical nodes at all four levels in a sequential manner to see if a datapacket should be held or forwarded. Embodiments of the present invention manage every datapacket through every node in the network with one single queue and checks the bandwidth limit at relevant hierarchical nodes simultaneously in a parallel architecture.

Each entry in the single queue includes fields for the pointer to the present source or destination node (user node), and all higher level nodes (parent nodes). The bandwidth limit of every node pointed to by this entry is tested in one clock cycle in parallel to see if enough credit exists at each node level to pass the datapacket along.

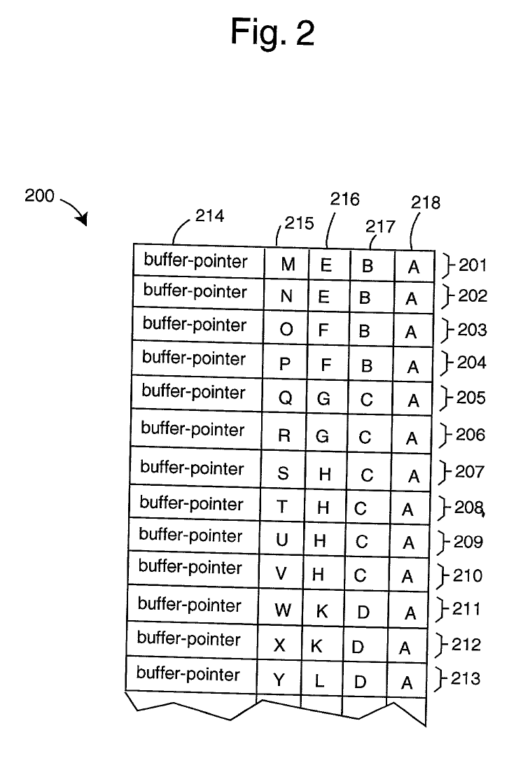

FIG. 2 illustrates a single queue 200 and several entries 201-213. A first entry 201 is associated with a datapacket sourced from or destined for subscriber node (M) 146. If such datapacket needs to climb the hierarchy of network 100 (FIG. 1) to access the Internet, the service level policies of the user node (M) 146 and parent nodes (E) 118, (B) 106 and (A) 102 will all be involved in the decision whether or not to forward the datapacket or delay it. Similarly, another entry 212 is associated with a datapacket sourced from or destined for subscriber node (X) 157. If such datapacket also needs to climb the hierarchy of network 100 (FIG. 1) to access the Internet, the service level policies of nodes (X) 157, (K) 130, (D) 110 and (A) 102 will all be involved in the decision whether or not to forward such datapacket or delay it.

There are many ways to implement the queue 200 and the fields included in each entry 201-213. The instance of FIG. 2 is merely exemplary. A buffer-pointer field 214 points to where the actual data for the datapacket resides in a buffer memory, so that the queue 200 doesn't have to spend time and resources shuffling the whole datapacket header and payload around. A hierarchical node pointer field 215-218 is divided into four subfields that represent the four possible levels of the hierarchy for each subscriber node 146-160 or nodes 126 and 128.

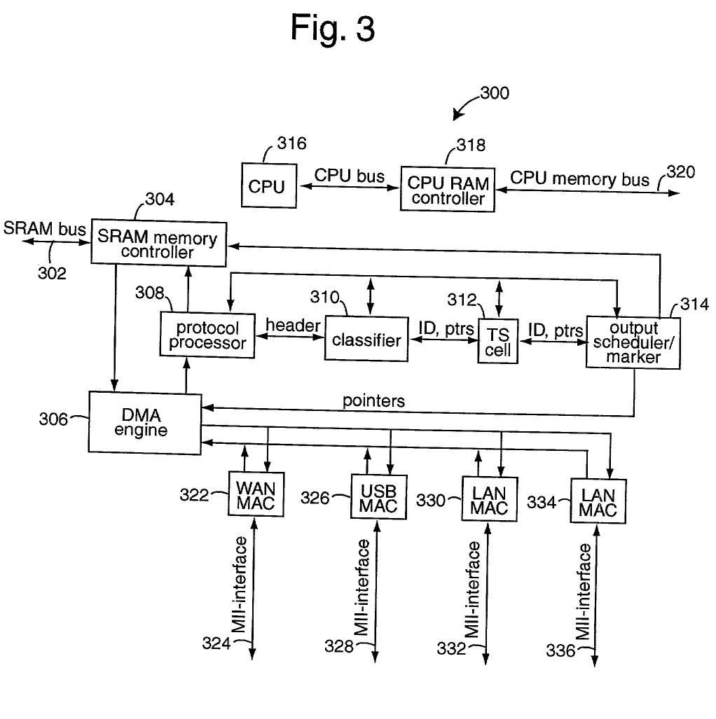

FIG. 3 represents a bandwidth management system 300 in an embodiment of the present invention. The bandwidth management system 300 is preferably implemented in semiconductor integrated circuits (IC's). The bandwidth management system 300 comprises a static random access memory (SRAM) bus 302 connected to an SRAM memory controller 304. A direct memory access (DMA) engine 306 helps move blocks of memory in and out of an external SRAM array. A protocol processor 308 parses application protocol to identify the dynamically assigned TCP/UDP port number then communicates datapacket header information with a datapacket classifier 310. Datapacket identification and pointers to the corresponding service level agreement policy are exchanged with a traffic shaping (TS) cell 312 implemented as a single chip or synthesizable semiconductor intellectual property (SIA) core. Such datapacket identification and pointers to policy are also exchanged with an output scheduler and marker 314. A microcomputer (CPU) 316 directs the overall activity of the bandwidth management system 300, and is connected to a CPU RAM memory controller 318 and a RAM memory bus 320. External RAM memory is used for execution of programs and data for the CPU 316. The external SRAM array is used to shuffle the network datapackets through according to the appropriate service level policies.

The datapacket classifier 310 first identifies the end user service level policy (the policy associated with nodes 146-160). Every end user policy also has its corresponding policies associated with all parent nodes of this user node. The classifier passes an entry that contains a pointer to the datapacket itself that resides in the external SRAM and the pointers to all corresponding nodes for this datapacket, i.e. the user nodes and its parent node. Each node contains the service level agreement policies such as bandwidth limit (CR and MBR) and the current available credit for a datapacket to go through.

A calculation periodically deposits credits in each node, e.g., one credit for enough bandwidth to transfer one byte of data through the respective node. Therefore more credits than the byte size of a packet is required in order for it to be sent through. When a decision is made to either forward or hold a datapacket represented by each corresponding entry 201-213, the node pointer field 214 is inspected. If all credit fields 215-218 have enough credit, then the respective datapacket is forwarded through the network 100 and the entry cleared from queue 200. The consumption of the credit is reflected in a decrement of bytes transferred from each involved node. Since the classifier 310 identifies all parent nodes of a user node, it allows the semiconductor implementation to incorporate parallel limit checking of available credit of all nodes (i.e. M, E, B, A) simultaneously in one clock cycle in the TS cell 312. This invention makes it possible for the bandwidth manager to operate at a very high data speed such as 10 Gbps.

The single queue 200 also prevents datapackets from-or-to particular nodes from being passed along out of order. The TCP/IP protocol allows and expects datapackets to arrive in random order, but network performance and reliability is best if datapacket order is preserved.

The service-level policies are defined and input by a system administrator. Internal hardware and software are used to spool and despool datapacket streams through at the appropriate bandwidths. In business model implementations of the present invention, subscribers are charged various fees for different levels of service, e.g., better bandwidth and delivery time-slots.

A network embodiment of the present invention comprises a local group of network workstations and clients with a set of corresponding local IP-addresses. Those local devices periodically need access to a wide area network (WAN) A class-based queue (CBQ) traffic shaper is disposed between the local group and the WAN, and provides for an enforcement of a plurality of service-level agreement (SLA) policies on individual connection sessions by limiting a maximum data throughput for each such connection. The class-based queue traffic shaper preferably distinguishes amongst voice-over-IP (voIP), streaming video, and datapackets. Any sessions involving a first type of datapacket can be limited to a different connection-bandwidth than another session-connection involving a second type of datapacket. The SLA policies are attached to each and every local IP-address, and any connection-combinations with outside IP-addresses can be ignored.

A variety of network interfaces can be accommodated, either one type at a time, or many types in parallel. For example, a wide area network (WAN) media access controller (MAC) 322 presents a media independent interface (MII) 324, e.g., 100BaseT fast Ethernet. A universal serial bus (USB) MAC 326 presents a media independent interface (MII) 328, e.g., using a USB-2.0 core. A local area network (LAN) MAC 330 has an MII connection 332. A second LAN MAC 334 also presents an MII connection 336. Other protocol and interface types include home phoneline network alliance (HPNA) network, IEEE-802.11 wireless, etc. Datapackets are received on their respective networks, classified, and either sent along to their destination or stored in SRAM to effectuate bandwidth limits at various nodes, e.g., “traffic shaping”.

The protocol processor 308, aids in the dynamic creation of policy associated with certain traffic flows. For example, to support video conferencing, one wants to be able to create a 300-Kbit/sec policy to support such calls whenever they start up. However, according to the H.323 protocol used in video conferencing, the actual port number associated with a particular call are negotiated during the call set up phase. The protocol processor 308, monitors the call set up phase of the H.323 protocol, extracts the negotiated parameters and then passes those to the micro processor so that the appropriate policy can be created.

The protocol processor 308 is implemented as a table-driven state engine, with as many as two hundred and fifty-six concurrent sessions and sixty-four states. The die size for such an IC is currently estimated at 20.00 square millimeters using 0.18 micron CMOS technology. Alternative implementations may control 20,000 or more independent policies, e.g., community cable access system.

The classifier 310 preferably manages as many as two hundred and fifty-six policies using IP-address, MAC-address, port-number, and handle classification parameters. Content addressable memory (CAM) can be used in a good design implementation. The die size for such an IC is currently estimated at 3.91 square millimeters using 0.18 micron CMOS technology.

The traffic shaping (TS) cell 312 preferably manages as many as two hundred and fifty-six policies using CIR, MBR, virtual-switching, and multicast-support shaping parameters. A typical TS cell 312 controls three levels of network hierarchy, e.g., as in FIG. 1. A single queue is implemented to preserve datapacket order, as in FIG. 2. Such TS cell 312 is preferably self-contained with its on chip-based memory. The die size for such an IC is currently estimated at 2.00 square millimeters using 0.18 micron CMOS technology.

The output scheduler and marker 314 schedules datapackets according to DiffServ Code Points and datapacket size. The use of a single queue is preferred. Marks are inserted according to parameters supplied by the TS cell 312, e.g., DiffServ Code Points. The die size for such an IC is currently estimated at 0.93 square millimeters using 0.18 micron CMOS technology.

The CPU 316 is preferably implemented with an ARM740T core processor with 8K of cache memory. MIPS and POWER-PC are alternative choices. Cost here is a primary driver, and the performance requirements are modest. The die size for such an IC is currently estimated at 2.50 square millimeters using 0.18 micron CMOS technology. The control firmware supports four provisioning models: TFTP/Conf_file, simple network management protocol (SNMP), web-based, and dynamic. The TFTP/Conf_file provides for batch configuration and batch-usage parameter retrieval. The SNMP provides for policy provisioning and updates. User configurations can be accommodated by web-based methods. The dynamic provisioning includes auto-detection of connected devices, spoofing of current state of connected devices, and on-the-fly creation of policies.

In an auto-provisioning example, when a voice over IP (VoIP) service is enabled the protocol processor 308 is set up to track SIP, or CQoS, or both. As the VoIP phone and the gateway server run the signaling protocol, the protocol processor 308 extracts the IP-source, IP-destination, port-number, and other appropriate parameters. These are then passed to CPU 316 which sets up the policy, and enables the classifier 310, the TS cell 312, and the scheduler 314, to deliver the service.

If the bandwidth management system 300 were implemented as an application specific programmable processor (ASPP), the die size for such an IC is currently estimated at 35.72 square millimeters, at 100% utilization, using 0.18 micron CMOS technology. About one hundred and ninety-four pins would be needed on the device package. In a business model embodiment of the present invention, such an ASPP version of the bandwidth management system 300 would be implemented and marketed as hardware description language (HDL) in semiconductor intellectual property (SIA) form, e.g., Verilog code.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A method for controlling the movement of datapackets in a hierarchical network, the method comprising the steps of:
using a class-based queue traffic shaper to enforce a plurality of service-level agreement policies on individual connection sessions by limiting a maximum data throughput for each connection in a hierarchical network;
distinguishing in said class-based queue traffic shaper amongst datapackets according to at least of their respective source and destination IP-addresses;
limit checking in one clock cycle for an entire network hierarchy above a particular node to enforce said plurality of service-level agreement policies according to said respective source and destination IP-addresses.

2. The method of claim 1, further comprising the steps of:
associating a service-level policy that limits allowable bandwidths to particular nodes in said hierarchical network;
classifying datapackets moving through said hierarchical network according to a particular service-level policy; and
managing all datapackets moving through said hierarchical network from a single queue in which each entry includes service-level policy bandwidth allowances for every hierarchical node in said network through which a corresponding datapacket must pass.

3. The method of claim 1, further comprising the step of:
testing in parallel whether a particular datapacket should be delayed in a buffer or sent along for every hierarchical node in said network through which it must pass.

4. The method of claim 1, further comprising the step of:
constructing a single queue of entries associated with corresponding datapackets passing through said hierarchical network such that each entry includes a pointer to the actual packet and pointers to the corresponding hierarchical node that point to the data structure containing available bandwidth credits in said network through which a corresponding datapacket must pass.

5. A means for managing the distribution of datapackets, comprising:
means for associating a service-level policy that limits allowable bandwidths to particular nodes in a hierarchical network;
means for classifying datapackets moving through said hierarchical network according to a particular service-level policy; and
means for managing all datapackets moving through said hierarchical network from a single queue in which each entry includes service-level policy bandwidth allowances for every hierarchical node in said network through which a corresponding datapacket must pass.

6. The means of claim 5, further comprising:
means for testing in parallel whether a particular datapacket should be delayed in a buffer or sent along for every hierarchical node in said network through which it must pass.

7. The means of claim 5, further comprising:
means for constructing a single queue of entries associated with corresponding datapackets passing through said hierarchical network such that each entry includes a pointer to the actual packet and pointers to the corresponding hierarchical node that point to the data structure containing available bandwidth credits for every hierarchical node in said network through which a corresponding datapacket must pass.

8. A network management system, comprising:
a protocol processor providing for header inspection of datapackets circulating through a network and providing for an information output comprising at least one of source IP-address, destination IP-address, port number, and application type;
a classifier connected to receive said information output and able to associate a particular datapacket with a particular network node and a corresponding service-level policy bandwidth allowance;
a single queue comprising individual entries related to said datapackets circulating through said network, and further related to all network nodes through which each must pass; and
a traffic-shaping cell providing for an inspection of each one of said individual entries and for outputting a single decision whether to pass through or buffer each of said datapackets in all network nodes through which each must pass.

9. The system of claim 8, further comprising:
an output scheduler and marker for identifying particular ones of the individual entries in the single queue that are to be passed through or buffered.

10. The system of claim 8, wherein:
at least one of the protocol processor, classifier, and traffic-shaping cell, are implemented as a semiconductor intellectual property and operate at run-time with the single queue.
